(19) United States
(12) Patent Application Publication
(10) Pub. No.: US 2025/0156241 A1
(43) Pub. Date: May 15, 2025

(54) SUBCLUSTERING CONTENT ITEMS FOR ALLOCATING COMPUTATIONAL RESOURCES ON A PER-SUBCLUSTER BASIS

(71) Applicant: Ancestry.com Operations Inc., Lehi, UT (US)

(72) Inventors: Gann Bierner, Oakland, CA (US); Robert Weis, Oakland, CA (US); Diego Estrada, Brentwood, CA (US); Rajani Raj, Union City, CA (US)

(21) Appl. No.: 18/939,990

(22) Filed: Nov. 7, 2024

Related U.S. Application Data
(60) Provisional application No. 63/597,584, filed on Nov. 9, 2023.

(51) Int. Cl. G06F 9/50; G06F 9/455

(52) U.S. Cl. CPC G06F 9/5077; G06F 9/45558; G06F 2009/4557

(57) ABSTRACT

The present disclosure is directed toward systems, methods, and non-transitory computer-readable media for generating data subclusters for content items stored in a genealogical content database and allocating computing resources to the subclusters on an individual, customized basis. For example, the disclosed systems segment stored content items according to content type to generate a number of type-specific subclusters of content items. In addition, the disclosed systems allocate different (numbers of) virtual machines of a cloud computing system to process data for each of the subclusters independently. The disclosed systems can allocate duplicate virtual machines (along with corresponding processing power and memory) to some subclusters for redundancy while allocating only a single set of virtual machines for others. In some embodiments, the disclosed systems can perform updates and/or other operations on data within the various subclusters using allocated virtual machines on an independent basis, irrespective of processes or operations for other subclusters.

### CROSS-REFERENCE TO RELATED APPLICATIONS

The present application claims priority to, and the benefit of, U.S. Provisional Application No. 63/597,584, titled SUBCLUSTERING CONTENT ITEMS FOR ALLOCATING COMPUTATIONAL RESOURCES ON A PER-SUBCLUSTER BASIS, filed on Nov. 9, 2023. The aforementioned application is hereby incorporated by reference in its entirety.

### BACKGROUND

Advancements in computing devices and networking technology have given rise to a variety of innovations in cloud-based genealogical data storage, sharing, and generation. For example, online historical content systems can provide access to digital genealogical content items across devices all over the world. To facilitate such access, modern historical content systems can provide search functions for sifting through large quantities of genealogical data to identify relevant genealogical content items, including birth certificates, digitized newspaper articles, images, census records, obituaries, court documents, military records, immigration records, and other types of digitized historical documents. Despite these advances, however, existing historical content systems continue to suffer from a number of disadvantages, particularly in terms of flexibility and computational efficiency.

As just suggested, certain existing historical content systems are inflexible. To elaborate, existing systems often utilize a one-size-fits-all approach to storing and performing operations on content items stored in genealogical databases. For example, many existing systems treat all content items homogenously in a data management sense by uniformly processing data queries or performing other operations on stored content items, regardless of their content types or other differentiating features. Such existing systems therefore indiscriminately allocate computational resources (e.g., virtual machines of a cloud computing system) to manage and operate on content items within a database, regardless of differing network traffic considerations, differing computational demands, or other factors that vary across the content items.

Due at least in part to their inflexible natures, many existing historical content systems are also computationally inefficient. More particularly, some existing systems consume excessive amounts of computational resources, such as processing power and memory, in maintaining and processing query requests for content items stored in a network database (e.g., a cloud-based database of genealogical content items). For example, because of their rigid approaches to allocating computational resources in a one-size-fits all manner, existing systems often assign too few resources to content items that require more resources (e.g., due to higher network traffic and/or higher computational demands) and/or too many resources to content times that require fewer resources. Consequently, existing systems are prone to poor performance for operations on content items with too few assigned resources while also wasting computational resources on content items allocated too many resources.

### SUMMARY

This disclosure describes one or more embodiments of systems, methods, and non-transitory computer-readable storage media that provide benefits and/or solve one or more of the foregoing and other problems in the art. In particular, the disclosed systems generate data subclusters for content items stored in a genealogical content database and allocate computing resources to the subclusters on an individual, customized basis. For example, the disclosed systems segment stored content items according to content type, generating a number of type-specific subclusters of content items. In addition, the disclosed systems allocate different (numbers of) virtual machines of a cloud computing system to process data for each of the subclusters independently. The disclosed systems can allocate duplicate virtual machines (along with corresponding processing power and memory) to some subclusters for redundancy while allocating only a single set of virtual machines for others. In some embodiments, the disclosed systems can perform updates, hot swaps, and/or other operations on data within the various subclusters using allocated virtual machines on an independent basis, irrespective of processes or operations for other subclusters.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which a subcluster system operates in accordance with one or more embodiments.

FIG. 2 illustrates an example overview of generating and allocating resources for subclusters in accordance with one or more embodiments.

FIG. 3 illustrates an example diagram of performing operations on subclusters in accordance with one or more embodiments.

FIG. 4 illustrates an example diagram of modifying allocations of virtual machines for subclusters in accordance with one or more embodiments.

FIG. 5 illustrates an example diagram for updating subclusters in accordance with one or more embodiments.

FIG. 6 an example series of acts for allocating virtual machines based on segmenting clustered digital content into subclusters for search requests in accordance with one or more embodiments.

FIG. 7 illustrates a block diagram of an example computing device for implementing one or more embodiments of the present disclosure.

FIG. 8 illustrates an example environment of a networking system having the subcluster system in accordance with one or more embodiments.

### DETAILED DESCRIPTION

This disclosure describes one or more embodiments of a subcluster system that can generate data subclusters for content items stored in a database and can allocate computing resources (e.g., virtual machines of a cloud computing system) to process data for the subclusters on an individual, customized basis. In certain use cases, user accounts interact with client devices to search genealogical databases for genealogical content items, such as birth certificates, digitized newspaper articles, images, census records, obituaries, court documents, military records, immigration records, and other types of digitized historical documents. For example, client devices associated with user accounts perform database queries to identify content items indicating family members to link within digital genealogical trees stored within one or more genealogical tree databases and/or to add genealogical content items or data derived therefrom to existing nodes within genealogical trees. As part of the search process, the subcluster system can allocate and utilize virtual machines of a cloud computing system to process data for individual subclusters that include content items corresponding to a search request or some other form of data query. Indeed, the subcluster system can determine a subcluster that corresponds to a search request and can utilize the allocated virtual machines for the subcluster to process data for the search request and to retrieve or determine content items corresponding to the search request (while leaving other virtual machines for other subclusters undisturbed).

It has been found that this approach advantageously addresses longstanding challenges in database management, as importing variegated content into a database, such as a genealogical-records database, can result in major inefficiencies in view of the structural differences of the imported content. Some content, for instance, contains comparatively little data but occurs in comparatively large numbers or instances, while other content contains comparatively greater volumes of data while occurring in comparatively smaller numbers or instances. Applying a one-size-fits-all storage and retrieval approach to such records can therefore result in inefficiencies as virtual machines are not optimally apportioned between collections or repositories of imported records. For instance, larger (or more powerful)-than-necessary virtual machines may be spun up and maintained for repositories of the aforementioned content that occurs in large numbers but where each instance comprises comparatively little data, and thus requires fewer computing resources. Redundancy requirements may likewise vary between such different categories of records.

To separate or segment stored content items into subclusters, the subcluster system can determine features or attributes associated with stored content items (e.g., content items stored across the entire system) and can group or cluster content items that share features together. For instance, the subcluster system can segment stored content items within a genealogical content database (or a database storing non-genealogical content items) by content type, such that each subcluster corresponds to, or includes content items of, a respective content type. As other examples, the subcluster system can determine features such as data sizes of content items, historical (and/or predicted) network traffic for content items, geographical regions associated with content items, names associated with content items, and/or dates associated with content items. In other words, the subclusters may be organized in any suitable way that improves efficient storage and retrieval of content, such as by organizing the subclusters based on observed or predicted user-search request patterns, such that particular searches only pertain to particular subclusters, thereby minimizing computation resources associated with fulfilling a particular search request. In some instances or implementation, search requests exhibit patterns associated with content type, and the subclusters are organized accordingly. In other implementations, search requests exhibit patterns associated with a geographical region associated with the content, and the subclusters are organized accordingly. Search request patterns corresponding to a plurality or combination of content attributes may be observed, with the subclusters organized accordingly. Thus, the subcluster system can further cluster content items according to one or more of these features such that each subcluster includes content items that share the one or more features.

In addition, the subcluster system can selectively engage or utilize computing resources to generate, manage, maintain, and modify each of the subclusters independently. Specifically, the subcluster system can allocate a number of virtual machines to maintain one subcluster without affecting or engaging other virtual machines allocated to other subclusters. By allocating virtual machines on a per-subcluster basis, the subcluster system tailors the amount of computing resources allocated to, and/or consumed by, each of the subclusters according to their respective computational demands. For instance, the subcluster system can allocate different numbers and/or sizes of virtual machines of a cloud computing system, where each virtual machine has its own processing capabilities and memory capacity. Thus, the subcluster system can allocate different levels of computational resources (e.g., numbers, sizes, capacities, and/or amount of replication of virtual machines) to different subclusters (and can modify them) according to the computational demands of the subclusters, where, for example, some subclusters include content items that receive more network traffic than content items in other subclusters and therefore require more resources.

Additionally, in response to various data queries, updates, hot swaps (e.g., changing out an index to accommodate updates), or other changes to stored content items (or data associated with the content items), the subcluster system can dynamically adjust virtual machines (and their constituent computational resources) allocated to each of the subclusters. For instance, in response to a search request from a client device, the subcluster system can determine a subcluster that includes content items corresponding to the search request and can engage the corresponding virtual machines to generate a search result from among the content items in the subcluster (without affecting virtual machines of other subclusters). As another example, in response to detecting a content update (e.g., ingestion of new content items that belong to a particular subcluster), the subcluster system can scale the number of virtual machines for relevant subclusters impacted by the update without scaling or modifying virtual machines of other subclusters. Such per-subcluster customization accommodates variations in updates (where some subclusters are updated while others are not), deployment cadence (where subclusters deploy at different frequencies), replication/redundancy (where some subclusters have redundant virtual hardware and others do not), and/or autoscaling for network traffic changes.

As suggested above, the subcluster system can provide improvements or advantages over existing historical content systems. For example, the subcluster system can improve flexibility over existing systems. Indeed, rather than utilizing the one-size-fits-all approach of many existing systems (e.g., systems reliant on federated searches which use a single large dataset for managing all content items together), the subcluster system can compartmentalize content items into subclusters, each with its own dedicated set of computational resources (e.g., virtual machines). Thus, even while storing content items in a single common database within a cloud network, the subcluster system can nevertheless implement the subclustering technique described herein to allocate different amounts of computational resources to different groups or subclusters of stored content items within the database. The subcluster system can therefore flexibly adapt amounts of computational resources dedicated to each of the subclusters according to their respective computational demands and can further adapt such resources based on fluctuations in demand.

Due at least in part to improving flexibility over existing historical content systems, the subcluster system can further improve computational efficiency over existing systems as well. To elaborate, the subcluster system consumes fewer computational resources, such as processing power and memory, compared to many existing systems that implement one-size-fits all resource allocation to stored content items (e.g., content items in a single cluster). Indeed, unlike such single-cluster systems that exhibit poor performance for operations on content items with too few assigned resources and/or that waste excessive computational resources on lower-demand content items, the subcluster system can flexibly adapt the amounts of computational resources for each subcluster for improved performance in some cases and for preservation of resources in other cases. Consequently, the subcluster system consumes performs better and more efficiently utilizes resources than prior systems.

In addition to configuring and modifying subclusters on an individualized basis, the subcluster system 102 can perform searches using the subclusters. For example, the subcluster system 102 can query subclusters on an individual basis and/or can query across multiple subclusters in a federated manner to produce integrated results. Indeed, the subcluster system 102 can assign and utilize aliases for subclusters where, in some cases, multiple aliases (and thus multiple subclusters) can correspond to a single search query (or search request). Because the subcluster system 102 manages the aliases (and associated metadata) for each subcluster, the subcluster system 102 further determines which queries correspond to which subclusters on an individual basis as well. In some embodiments, the subcluster system 102 combines metadata objects for different subclusters corresponding to a search query (or search request) into a single object, while in other embodiments the subcluster system 102 keeps the metadata objects separate and identifies which one(s) correspond to a search query (or search request). Accordingly, the subcluster system 102 can generate consistent, accurate search results in an efficient manner using subclusters.

While some embodiments of the subcluster system relate to the context of genealogical data and genealogical content items, the subcluster system can perform the processes described herein on other data as well. Additionally, as illustrated by the foregoing discussion, the present disclosure utilizes a variety of terms to describe features and benefits of the subcluster system. Additional detail is hereafter provided regarding the meaning of these terms as used in this disclosure.

As used herein, the term “content item” refers to a digital object or a digital file that includes information (e.g., genealogical information) interpretable by a computing device (e.g., a client device) to present information to a user. A content item can include a file such as a digital text file, a digital image file, a digital audio file, a webpage, a website, a digital video file, a web file, a link, a digital document file, or some other type of file or digital object. A content item can have a particular file type or file format, which may differ for different types of digital content items (e.g., digital documents, digital images, digital videos, or digital audio files). In some cases, a content item can refer to a genealogical content item that includes or depicts historical or genealogical information, such as a digitized birth certificate, a digitized newspaper article, a digitized photograph of a relative, a digitized census record, a digitized obituary, a digitized military record, a digitized court document, a digitized DNA analysis, or a digitized family tree. In some embodiments, a genealogical content item includes a content item selected or identified to surface to a client device, such as an item in a search result, a record hint (e.g., a stored genealogical content item automatedly identified as being potentially pertinent to a particular user based on their genealogical research), a digital story (e.g., a stored collection of genealogical content items arranged for a particular person, topic, or entity of a genealogical data system), a digital image (e.g., a digitized photograph), a new person hint (e.g., a node to add to a genealogical tree), a member tree hint (e.g., a prediction for correcting or generating a node within a genealogical tree of a user account), or a DNA match (e.g., a record indicating a DNA match of a user account to a relative whose information is stored in a genealogical data system).

In some embodiments, a content item can belong to, or be associated with, a content type. As used herein, the term “content type” (or sometimes simply “type”) refers to a type or category that indicates or labels data included within a content item. Each content item can belong to one or more content types that label or describe the information it contains, such as DNA information, images, date of birth, spouse name, or other information. In some cases, a content type refers to a filetype of a content item and/or a source item where data is extracted. Example content types include digitized photographs, digitized census records, digitized obituaries, digitized military records, digitized court documents, digitized DNA analysis records, digitized family trees, digitized newspaper records with, in embodiments, accompanying extracted entities and relationships, pet DNA records, and/or relationship-prediction records.

As mentioned, in some embodiments, the subcluster system groups or clusters stored content items into data subclusters. As used herein, the term “data subcluster” (or sometimes simply “subcluster”) refers to a grouping of content items that share one or more features or attributes, such as content types, data sizes, historical (and/or predicted) network traffic, geographical regions, names, dates, specialization data, collection of origin, and/or name-sharding data. In some cases, a subcluster can include commonly grouped content items stored within a single database and/or subdivided from a larger dataset or supercluster. Even while stored in a single common database, each subcluster is allocated or assigned its own computational resources, such as virtual machines that come with their own processing capabilities and memory capacities. In some embodiments, a subcluster refers to a newly introduced SOLR data construct that includes one or more collections which represent smaller denominations of stored content items, where each collection includes one or more shards designating the physical distribution (e.g., server locations) of content items.

Relatedly, as used herein, the term “specialization data” refers to computer data that indicates or defines relationships between data fields of content items and/or between search terms and alternative search terms. For example, specialization data defines a relationship between a first data field indicating a mother's name in a content item and a second data field indicating a father's name in a content item. In some cases, specialization data defines or labels the relationship using metadata that is usable as an alternative search term. For instance, specialization data can define a relationship or commonality between the “mother” field and the “father” data field by labeling or determining that both fields relate to the term “parent” which can be used as an additional or alternative search term to identify content items that include the term “parent” but not “mother” or “father.”

In addition, the term “name-sharding data” (or “name sharding”) refers to computer data that defines or indicates separations or delineations between collections of content items grouped into different shards according to name data. For example, name-sharding data defines or indicates partitions for horizontally dividing content items into different collections or shards for distributing across a cloud computing system (e.g., at different servers). A first collection (which includes one or more shards) separated by name-sharding data can include content items corresponding to a first set of names (e.g., surnames of a person of interest in the content item, the surnames beginning with the letters “AAA” through “ART”) while a second collection (made up of one or more shards) includes content items corresponding to a second set of names (e.g., surnames beginning with the letters “ART” through “AZZ”). In some cases, the subcluster system generates subclusters to include multiple collections separated by name-sharding data, while in other cases the name-sharding data informs the separation of the subclusters themselves (rather than only the separation of collections within subclusters).

Additionally, as used herein, the term “virtual machine” (or sometimes simply “machine”) refers to a virtualized, digital version, instance, or model of a physical computing device, such as a server that includes processors and memory. For example, a virtual machine can execute processes using processing, storage, and memory components of distributed servers in different physical locations (communicating over a network) working together to form a single machine that acts as its own computer or entity. A single cloud computing system can generate and facilitate many virtual machines simultaneously, where each instance of a virtual machine operates independently of (but perhaps in communication with) the others, with assigned (and adaptive) processing, storage, and memory components from servers of the cloud computing system.

In addition, as used herein, the term “cloud computing system” refers to a distributed computing system that includes one or more servers with processors for executing processes initiated at workstations (or other client devices) and which communicate (amongst themselves and with client devices) over a network. A cloud computing system can include machine learning components, applications, and scripts that assist or facilitate execution of various processes by, for example, determining computational resources to allocate for processes, modifying resources over time as processing requirements fluctuate, terminating processes that reach a maximum lifespan and/or that have gone idle (as indicated by CPU usage and/or memory usage). Example cloud computing systems include AMAZON WEB SERVICES (“AWS”), MICROSOFT AZURE, GOOGLE CLOUD PLATFORM, and IBM CLOUD.

In some embodiments, the subcluster system utilizes a cloud-computing orchestrator to identify subclusters corresponding to data queries and to perform operations on content items in the subclusters. As used herein, the term “cloud-computing orchestrator” (or “orchestrator”) refers to a computer program (or part of a computer program) or platform that orchestrates or manages data queries, operations, and processes for subclusters. For example, a cloud-computing orchestrator analyzes various data (e.g., field metadata, subcluster metadata, name-sharding data, and/or specialization data) associated with subclusters to identify one or more subclusters (and content items within the subclusters) that correspond to a search request and/or to perform other operations on the subclusters. In some cases, a cloud-computing orchestrator is part of (e.g., hosted at servers managed by) a cloud computing system, while in other cases a cloud-computing orchestrator is part of the subcluster system.

Along these lines, the subcluster system utilizes a façade pattern to determine where to search in response to a search query (or search request). As used herein, the term “façade pattern” (or simply “façade”) includes or refers to a customized computer code segment, subroutine, function, or application that determines which network locations (e.g., servers) to search in response to a search query. For example, a façade pattern includes, or is made up of, computer code and corresponding logic instructing a search engine (as a subcomponent of the subcluster system) to search within content items hosted at or stored on designated shards or servers.

In one or more embodiments, the subcluster system (using the façade pattern) determines which shards to search based on subcluster aliases. As used herein, the term “subcluster alias” (or simply “alias”) includes or refers to a virtual name assigned to a set of collections subsumed within, or that make up, a subcluster. An alias is assignable or attributable to a single collection (i.e., a collection alias which covers multiple shards) and/or to multiple collections (i.e., a subcluster alias which covers multiple collections) for querying as if the alias was a single data entity or location, as opposed to multiple separate searchable locations. In some cases, a subcluster alias refers to a newly introduced layer or version of SOLR aliases designated for a subcluster and which indicates one or more shards hosting data (e.g., content items) within one or more collections of the subcluster.

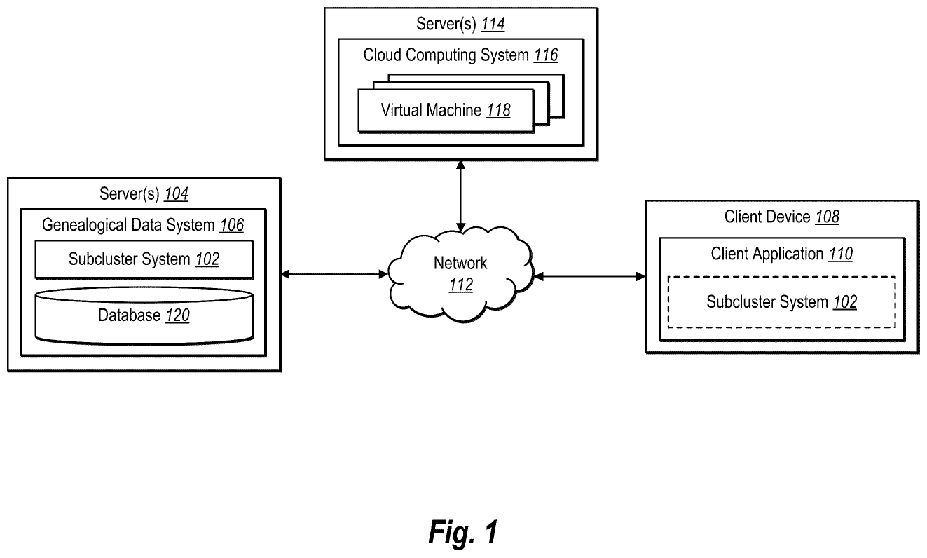

Additional detail regarding the subcluster system will now be provided with reference to the figures. For example, FIG. 1 illustrates a schematic diagram of an example system environment for implementing a subcluster system 102 in accordance with one or more implementations. An overview of the subcluster system 102 is described in relation to FIG. 1. Thereafter, a more detailed description of the components and processes of the subcluster system 102 is provided in relation to the subsequent figures.

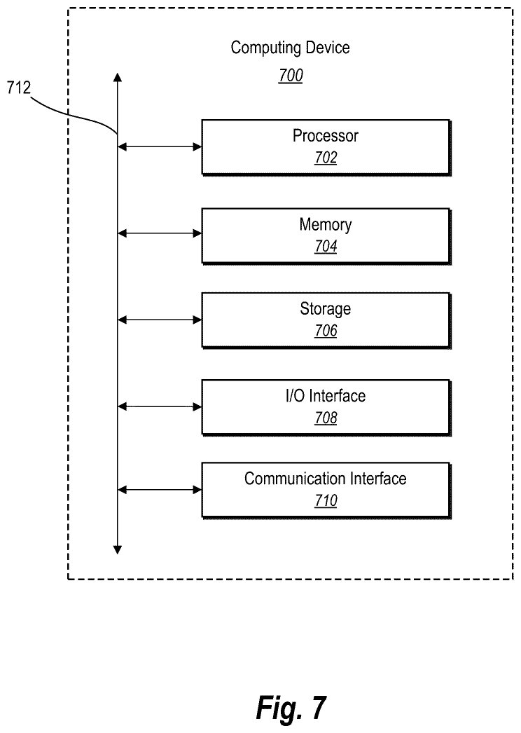

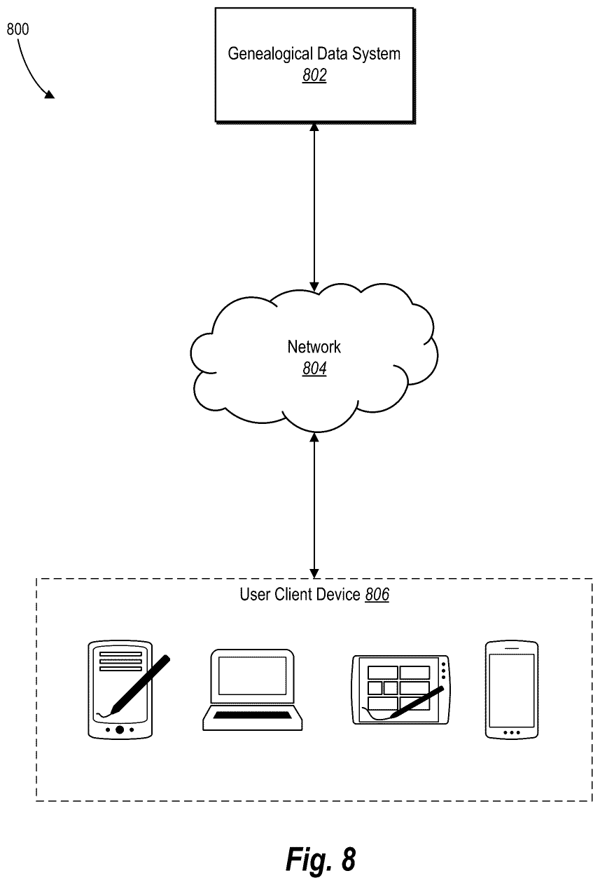

As shown, the environment includes server(s) 104, a client device 108, server(s) 114, and a network 112. Each of the components of the environment can communicate via the network 112, and the network 112 may be any suitable network over which computing devices can communicate. Example networks are discussed in more detail below in relation to FIGS. 7-8.

As mentioned above, the example environment includes a client device 108. The client device 108 can be one of a variety of computing devices, including a workstation, a smartphone, a tablet, a smart television, a desktop computer, a laptop computer, a virtual reality device, an augmented reality device, or another computing device as described in relation to FIGS. 7-8. The client device 108 can communicate with the server(s) 104 and/or the server(s) 114 via the network 112. For example, the client device 108 can receive user input from respective users interacting with the client device 108 (e.g., via the client application 110) to, for instance, perform a search of content items stored in the database 120. In addition, the subcluster system 102 on the server(s) 104 can receive information relating to the search query (including search terms) based on the input received by the client device 108.

As shown, the client device 108 can include a client application 110. In particular, the client application 110 may be a web application, a native application installed on the client device 108 (e.g., a mobile application, a desktop application, etc.), or a cloud-based application where all or part of the functionality is performed by the server(s) 104. Based on instructions from the client application 110, the client device 108 can present or display information, including a user interface for submitting search requests for global searches (to search for content items across the database 120) and/or for content-based searches (to search among a particular type or category of content items).

As illustrated in FIG. 1, the example environment also includes the server(s) 104. The server(s) 104 may generate, track, store, process, receive, and transmit electronic data, such as search requests, search results, and/or data associated with various subclusters. For example, the server(s) 104 may receive data from the client device 108 in the form of a search request. In addition, the server(s) 104 can transmit data to the client device 108 in the form of a search result generated by a virtual machine 118 of the cloud computing system 116 (e.g., for display within a graphical user interface). Indeed, the server(s) 104 can communicate with the client device 108 to send and/or receive data via the network 112. In some implementations, the server(s) 104 comprise(s) a distributed server where the server(s) 104 include(s) a number of server devices distributed across the network 112 and located in different physical locations. The server(s) 104 can comprise one or more content servers, application servers, communication servers, web-hosting servers, machine learning server, and other types of servers.

As shown in FIG. 1, the server(s) 104 can also include the subcluster system 102 as part of a genealogical data system 106. The genealogical data system 106 can communicate with the client device 108 to perform various functions associated with the client application 110 such as managing user accounts, managing genealogical data, managing genomic-sequencing data, managing genealogy trees, managing genealogical-content items, and facilitating user interaction with, analysis, and/or sharing of, genomic-sequencing data, genealogy trees, and/or genealogical-content items. Indeed, the genealogical data system 106 can include a network-based cloud storage system to generate, manage, store, and maintain genomic-sequencing data for various samples associated with user accounts and/or to generate, manage, store, and maintain genealogical-content items and genealogy trees-related data vis-à-vis user accounts. For instance, the genealogical data system 106 can generate and store genomic-sequencing data for user accounts, indicating various propensities and probabilities for biological traits and conditions, as well as relationships between individuals, geographic regions, and/or other information. In addition, the genealogical data system 106 can utilize genealogical data across various content items and user accounts to generate and maintain a universal genealogy tree that reflects the relatedness or consanguinity between nodes corresponding to all user accounts and other individuals indicated by stored genealogical content items. In some embodiments, the subcluster system 102 and/or the genealogical data system 106 utilize a database 120 to store and access information such as content items, user account data, subcluster data, and/or other information.

Although FIG. 1 depicts the subcluster system 102 located on the server(s) 104, in some implementations, the subcluster system 102 may be implemented by (e.g., located entirely or in part on) one or more other components of the environment. For example, the subcluster system 102 may be implemented in whole or in part by the client device 108. For example, the client device 108 and/or a third-party system can download all or part of the subcluster system 102 for implementation independent of, or together with, the server(s) 104.

As further illustrated in FIG. 1, the subcluster system 102 includes server(s) 114 that house or are operated by a cloud computing system 116. In particular, the cloud computing system 116 can include or manage the server(s) 114 in a distributed environment across different physical locations. The cloud computing system 116 can manage and maintain data for subclusters of content items stored in the database 120. For instance, the cloud computing system 116 can spin up and utilize a virtual machine 118 to execute a process initiated at the client device 108 (e.g., via the client application 110) for generating a search result from a subcluster. Indeed, the cloud computing system 116 can determine and allocate computational resources, such as processing capacity, storage, and memory, to perform the process at the virtual machine 118. The cloud computing system 116 can further include a cloud-computing orchestrator that monitors and manages content items to perform processes across virtual machines based on search requests, updates, hot swaps, or other data events.

In some implementations, though not illustrated in FIG. 1, the environment may have a different arrangement of components and/or may have a different number or set of components altogether. For example, the client device 108 may communicate directly with the subcluster system 102, bypassing the network 112. As another example, the environment may include multiple client devices, each associated with a different user account. As yet another example, the database 120 can be maintained by the cloud computing system 116 on the server(s) 114 and in communication with the subcluster system 102 via the network 112. In addition, the environment can include a database located external to the server(s) 104 (e.g., in communication via the network 112) or located on the server(s) 104, the server(s) 114, and/or on the client device 108.

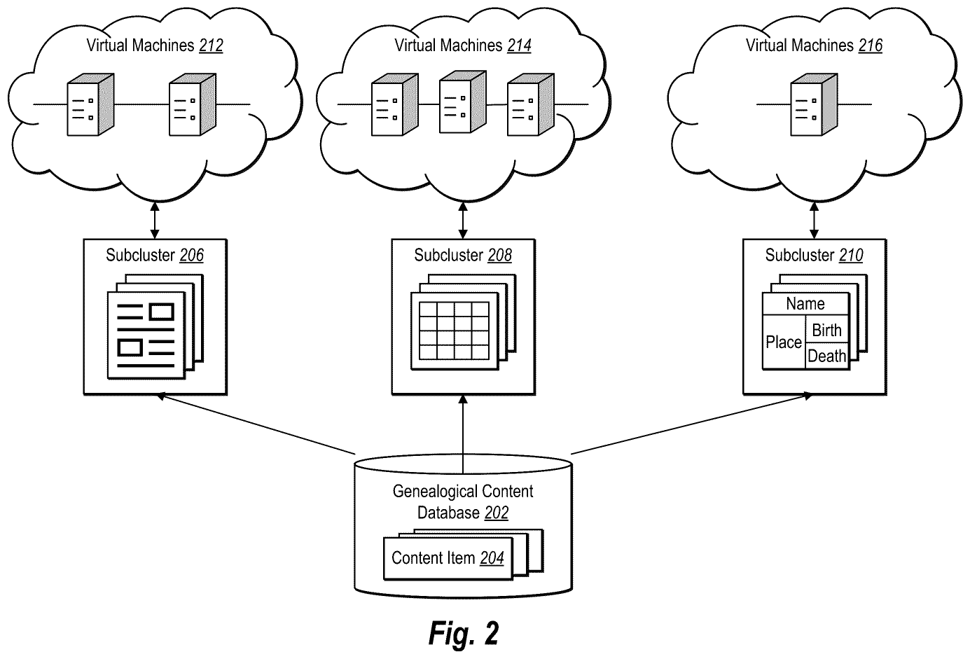

As mentioned above, the subcluster system 102 can generate subclusters of content items stored in a database, such as a genealogical content database. In particular, the subcluster system 102 can generate subclusters based on shared features of content items and can further allocate virtual machines to perform operations (e.g., searches, updates, and hot swaps) on subclusters on an individual, per-subcluster basis. FIG. 2 illustrates an example overview of generating, and allocating computational resources for, subclusters of content items in accordance with one or more embodiments. Additional detail regarding the various acts and techniques introduced in FIG. 2 is provided thereafter with reference to subsequent figures.

As illustrated in FIG. 2, the subcluster system 102 identifies and manages a plurality of content items (including the content item 204) within a genealogical content database 202 (e.g., the database 120). Indeed, the subcluster system 102 identifies content items of various content types, varying network traffic, varying data sizes, varying names, varying geographic areas, varying dates, and/or other varying features. In some embodiments, the subcluster system 102 determines a content type by identifying metadata for a content item designating its content type as a label. For instance, the subcluster system 102 maintains content items of various types that are predefined or pre-designated based on the sources of and/or contents within the content items. In some cases, the subcluster system 102 determines a content type of person-specific newspaper articles which includes many billions of records made up of relatively small amounts of information such as names and dates extracted using suitable entity-extraction and relation-detection modalities from, e.g., birth, marriage, and death announcements identified in historical newspaper images.

In some cases, the subcluster system 102 determines a content type for the content item 204 by analyzing the content item 204 to determine or generate a label describing the data therein (e.g., using a content-type classification neural network trained on content items and corresponding content-type labels). For instance, the subcluster system 102 utilizes a topic-extraction neural network to predict a topic for the content item 204 based on its internal data (e.g., text, images, names, and dates) and uses the topic as a label for the content item 204. In some embodiments, the subcluster system 102 thus analyzes content items within a database to designates a content type for each content item. The topic-extraction classification neural network may be a neural network as described in U.S. Patent Application Publication No. 2024/0005690, published Jan. 4, 2024, and which is hereby incorporated in its entirety by reference.

As just noted, in addition to determining content types, the subcluster system 102 can determine network traffic associated with content items. To determine network traffic for the content item 204, the subcluster system 102 can monitor (or determine based on metadata accompanying the content item 204) clicks, selections, searches, shares, and/or other network interactions with the content item 204. For instance, the subcluster system 102 can determine frequency, recency, and periodicity of one or more of the aforementioned interactions in relation to the content item 204 and can generate a network traffic score for the content item 204 based on a (weighted) combination. In some cases, for example, the subcluster system 102 weights shares more than clicks and further adjusts weights for the shares and clicks by their respective frequencies, recencies, and periodicities. The subcluster system 102 can thus generate a combined, weighted network traffic score for the content item 204 based on historical interactions (by one or more user accounts) with it and optionally with like content.

In some cases, the subcluster system 102 categorizes content items into network traffic buckets. For example, network traffic scores above an upper threshold denote high network traffic, network traffic scores between an upper threshold and a lower threshold denote moderate network traffic, and network traffic scores below a lower threshold denote low network traffic. The subcluster system 102 can thus distinguish between content items stored within the genealogical content database 202 based on network traffic scores. While three network-traffic score categories are described, it will be appreciated that the disclosure is not limited thereto; rather, the subcluster system 102 may utilize, in embodiments, any suitable number of discretizations of content based on associated network traffic, such as two categories, four categories, five categories, etc.

As indicated, the subcluster system 102 can determine a data size of the content item 204. In particular, the subcluster system 102 can analyze the content item 204 to determine a number of bytes or an amount of memory allocation required to store the content item 204. In some cases, the subcluster system 102 categories content items based on data sizes, where content items requiring fewer than a threshold number of bytes are separated from content items requiring more than the threshold number of bytes. In some embodiments, the subcluster system 102 separates into more than two data-size categories. While two data-size categories are described, it will be appreciated that the disclosure is not limited thereto; rather, the subcluster system 102 may utilize, in embodiments, any suitable number of discretizations of content based on data size, such as three categories, four categories, etc.

As further indicated, the subcluster system 102 can determine a geographic area for the content item 204. More specifically, the subcluster system 102 can determine a geographic area or region indicated by or determined to be associated with the content item 204. In some embodiments, the subcluster system 102 determines a geographic area by determining a source country or source region of the content item 204. For example, the subcluster system 102 determines a geographic area for a military record as a country associated with the indicated military organization. As another example, the subcluster system 102 determines a geographic area for a birth certificate as a country where the individual was born and which issued the birth certificate. As yet another example, the subcluster system 102 determines a geographic region associated with a collection of documents with which the record of interest was imported, for example a “Texas Birth Certificates” collection of records may be associated with the U.S. state of Texas. As yet another example, the subcluster system 102 associates a location identified within or associated with the record with another geographic location pertaining to a preexisting subcluster. For example, a record may pertain to marriage license issued in a city named “Daugavpils,” and the subcluster system 102 accesses a geographic location database to ascertain that Daugavpils is a city in the current boundaries of the country of Latvia. In embodiments, the subcluster system 102 is configured to access a historical locations database to determine that, for a record pertaining to a particular year, the various geographic locations (including city, state/province/county, country, etc.) are different than the existing geographic locations given historical changes to geographic boundaries; the record may be associated variously, as suitable, with a particular subcluster based on another metadatum such as year. Thus, a death announcement a.k.a obituary published in Morgantown, West Virginia in 1852 may be associated by the subcluster system 102 with the state of Virginia, within whose boundaries Morgantown fell at that time, while a death announcement published in Morgantown, West Virgina in 1952 may by contrast be associated by the subcluster system 102 with the state of West Virginia. The subcluster system 102 can thus distinguish content items according to geographic areas.

In some cases, the subcluster system 102 determines (and separates content items according to) other features for the content item 204, such as names and dates indicated within the content item 204. In embodiments, the subcluster system 102 relies on or receives input from an entity extraction and relation detection ML model configured to receive, as input, an image comprising the historical record, and to perform transcription (such as optical character recognition) thereon. The extracted text data may then be assed to the entity extraction and relation detection ML model to detect and resolve named-entities and other entities with relationships therebetween using the trained ML model. Thus an image of an obituary may be processed by the trained entity-extraction and relation-detection ML model to output named entities including the name of the deceased and names of close relatives thereof, with accompanying dates and places information. These may be received along with the input image by the subcluster system 102 with the received entity and relation data used to distinguish between received content items on the basis of one or more of the received entities and/or relationships. The trained entity-extraction and relation-detection ML model may be configured similar to the entity-extraction/relation-detection ML model(s) in U.S. Patent Application Publication No. 2024/0005690, published Jan. 4, 2024.

The subcluster system 102 likewise determines features for other content items within the genealogical content database 202. Accordingly, the subcluster system 102 can distinguish between content items based on one or more (e.g., a combination of) the above features, including content type, network traffic, data size, geographic area, names, and/or dates. As described below, the subcluster system 102 can further use these distinctions to generate subclusters for managing storage and searching of distinct groups of content items with respective virtual machines.

As just mentioned, and as further illustrated in FIG. 2, the subcluster system 102 segments or separates the content items within the genealogical content database 202 into subclusters. Specifically, the subcluster system 102 generates a subcluster 206, a subcluster 208, and a subcluster 210 that each include content items that share one or more of the above features, including content type, network traffic, data size, geographic area, names, and/or dates. For instance, the subcluster system 102 separates stored content items according to content type, where the subcluster 206 includes birth, marriage, and death images, the subcluster 208 includes military records, and the subcluster 210 includes person-specific newspaper article content items. In some cases, the subclusters can also or alternatively include content items with different levels of network activity, different data sizes, and/or different geographic regions.

As noted, the subcluster system 102 also determines resource allocations for subclusters. For example, the subcluster system 102 determines virtual machines 212 to allocate to the subcluster 206, virtual machines 214 to allocate to the subcluster 208, and virtual machines 216 to allocate to the subcluster 210. To allocate the virtual machines 212 to the subcluster 206, the subcluster system 102 determines a computational demand of the subcluster 206 based on factors such as a total data size of the subcluster 206, network traffic across content items within the subcluster 206, and/or frequency/cadence and/or data size of updates for content items in the subcluster 206 (e.g., ingestion of new content items to add to the subcluster 206). These factors may be dynamic, with the subcluster system 102 configured to adjust based on changes thereto. As seen, the subcluster 210 may be arranged by the subcluster system 102 so as to include or correspond to categorizations of content such as name-, place-, birth-event-, and/or death-event-specific categorizations.

Similarly, the subcluster system 102 allocates the virtual machines 214 based on one or more of the same factors, this time for the subcluster 208. Likewise, the subcluster system 102 allocates the virtual machines 216 for the subcluster 210 in a similar fashion. As shown, the subcluster system 102 allocates virtual machines based on the respective computational demands of the subclusters 206, 208, 210, where the virtual machines 214 include a greater number (or a greater computational capacity/power) than the virtual machines 212 which are in turn greater than the virtual machines 216. By allocating virtual machines independently for each subcluster, the subcluster system 102 isolates the computational operation of the subclusters (even though the content items are all stored in the genealogical content database 202), including adjustments to the virtual machines 212, 214, 216 due to fluctuations in computational demand, network traffic, or other factors. Indeed, the subcluster system 102 introduces the notion of subclusters (particularly within the APACHE SOLR context) that each include multiple collections, and which are independently manageable with respective compute instances and resources (and which are each reference-able with a respective alias).

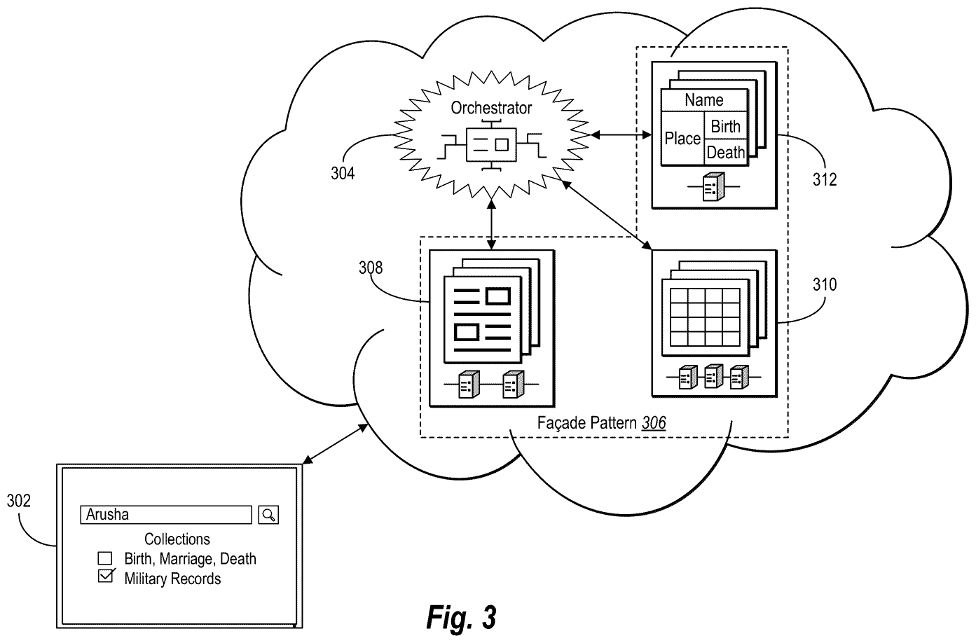

As mentioned above, in certain embodiments, the subcluster system 102 performs operations or processes on content items within subclusters. For example, the subcluster system 102 generates a search result in response to a search request from a client device 108 by populating the search result with content items from one or more subclusters 206, 208, 210. FIG. 3 illustrates an example diagram of performing operations on content items in subclusters in accordance with one or more embodiments.

As illustrated in FIG. 3, the subcluster system 102 receives a search request from a client device 302. More specifically, the subcluster system 102 receives a content-based search request that indicates a particular collection or content type (in this case, military records) for searching or within which to search the term “Arusha.” In response to receiving the search request, the subcluster system 102 utilizes a cloud-computing orchestrator 304 to determine or identify a subcluster corresponding to the search terms and/or the indicated category.

For instance, the subcluster system 102 uses the orchestrator 304 to analyze subcluster aliases assigned to various subclusters and to compare the aliases with the search query (or search request). Indeed, the subcluster system 102 generates and assigns aliases to the subcluster 308, the subcluster 310, and the subcluster 312. By assigning subcluster aliases, the subcluster system 102 enables and facilitates searching among multiple collections at once, where multiple collections can be within a single subcluster, and where each collection can include one or more shards storing or housing content items (where the shards designate the physical server locations where individual content items are stored). Compared to prior systems, the subcluster system 102 thus facilitates more-efficient searching on a per-subcluster basis by identifying a subcluster with an alias corresponding to a search query.

In some cases, in response to a search query, the subcluster system 102 uses the orchestrator 304 to analyze subcluster metadata, field metadata, name-sharding data, and/or specialization data associated with the subclusters, such as the subcluster 308, the subcluster 310, and the subcluster 312. The orchestrator 304 thus identifies one or more subclusters and/or content items within the subclusters to provide or search within as part of a search result. In the illustrated example, the orchestrator 304 determines that the subcluster 310, which stores military records, includes content items for the search request. To analyze the various data and identify content items for a search request, the orchestrator 304 can engage the virtual machines dedicated to the respective subcluster(s) to determine the various data and search among the content items to identify those that match the search request.

In some embodiments, the orchestrator 304 interacts with a façade pattern 306 overlaying the subclusters 308, 310, 312 to perform a search and generate search results in response to the search request. In particular, the orchestrator 304 may be programmed to consider or detect distinctions between (aliases of) subclusters of content items. By generating a façade pattern 306 to overlay the subcluster 308, the subcluster 310, and the subcluster 312, the subcluster system 102 provides a custom code or a custom software design pattern that serves as an object for interfacing the orchestrator 304 with the subclusters 308, 310, 312. Indeed, the façade pattern 306 includes computer code that maps data for the subclusters 308, 310, 312 to functions or operations of the orchestrator 304 such that the orchestrator 304 can identify shards housing content items to provide in response to a search request. Thus, the orchestrator 304 can interact with, and execute functions of, the façade pattern 306 to identify the content items (within the subcluster 310) that match the search request.

While FIG. 3 illustrates an example of a content-based search (which designates “Military Records” as the content type for the content-based search and which thus narrows the set of potential subclusters to search from the outset), the subcluster system 102 can also perform operations using the orchestrator 304 in response to a global search. For example, the subcluster system 102 can utilize the orchestrator 304 to interact with the façade pattern 306 to analyze data of subclusters to determine which subclusters correspond to a global search request. Thus, rather than a content-based search which may only require searching a smaller set of virtual machines of a single subcluster (the subcluster indicated by the content-based search request) to identify matching content items, the subcluster system 102 utilizes the orchestrator 304 (guided or informed by the façade pattern 306) to search among (aliases of), and engage virtual machines of, a larger number of subclusters to identify matching content items.

Although FIG. 3 illustrates an example of receiving a search request to perform operations on subclusters, in some embodiments the subcluster system 102 performs operations based on other events. For instance, the subcluster system 102 utilizes the orchestrator 304 to identify the appropriate subcluster for adding newly ingested content items and/or for hot swapping indexes of subclusters.

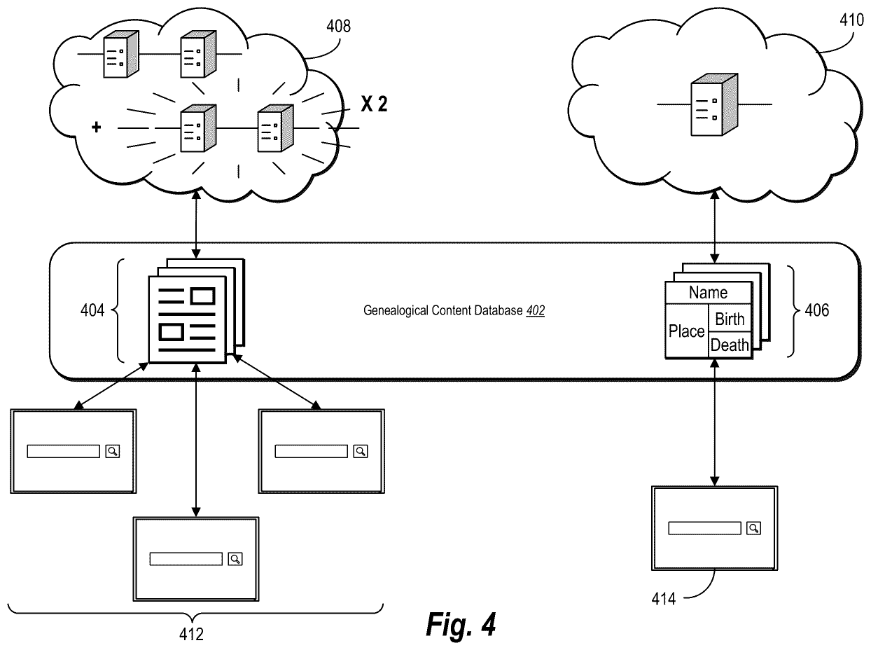

As noted above, in certain described embodiments, the subcluster system 102 modifies or scales computational resources for subclusters on an individual, per-subcluster basis. In particular, the subcluster system 102 automatically (e.g., without user interaction) spins up and/or spins down virtual machines for different subclusters based on fluctuations in computational demand for the subclusters. FIG. 4 illustrates modifying allocations of virtual machines for scaling subclusters in accordance with one or more embodiments.

As illustrated in FIG. 4, the subcluster system 102 stores content items in a genealogical content database 402. Within the genealogical content database 402, the subcluster system 102 generates a subcluster 404 for birth, marriage, and death record images and further generates a subcluster 406 for person-specific newspaper article content items. The subcluster system 102 can generate additional or alternative subclusters as well. In some cases, the person-specific newspaper article content items corresponding to the subcluster 406 include only a few items of information (e.g., name, place, birth date, and/or death date) and have very small data sizes (e.g., fewer than a threshold number of bytes). However, the genealogical content database 402 can store many billions (e.g., more than 30 billion) of person-specific newspaper article content items, and the subcluster 406 can thus require vast amounts of data storage and many virtual machines without the intelligent data management of the subcluster system 102. The birth, marriage, and death record images in the subcluster 404, by contrast, can include high-resolution images or scans representing digitized versions of birth, marriage, and death record documents and can have much larger data sizes than the person-specific newspaper article content items, which may comprise cropped versions of original newspaper images.

As shown, the subcluster system 102 receives network traffic from various client devices in relation to the content items in the subclusters. For instance, the subcluster system 102 receives search requests, selections, browse inputs, or other client-device inputs indicating or causing retrieval of content items within the subclusters 404, 406. As shown, the subcluster system 102 receives higher network traffic for the subcluster 404 represented by the larger number of client devices 412. In addition, the subcluster system 102 receives lower network traffic for the subcluster 406 represented by the smaller number of client devices 414. In some scenarios, the network traffic for the subcluster 404 is much larger (e.g., multiple times or orders of magnitude larger) than the network traffic of the subcluster 406. Consequently, the subcluster system 102 determines that the computational load or demand for the subcluster 406 and the subcluster 404 are different, requiring different levels of resources to facilitate the network traffic.

The subcluster system 102 can scale based on these network traffic data. Due to the higher network traffic for the subcluster 404, the subcluster system 102 allocates more virtual machines to accommodate the processing of the content items in the subcluster 404 for the larger number of requests. Indeed, as shown, the subcluster system 102 allocates a larger number of virtual machines 408 for the subcluster 404 than for the subcluster 406. Thus, in response to client-device inputs for search requests, browses, or other interactions causing retrieval of content items in the subcluster 404, the subcluster system 102 utilizes the allocated virtual machines 408 to process subcluster data and identify content items within the subcluster 404 corresponding to the search requests or other interactions from the client devices 412. The subcluster system 102 likewise utilizes the virtual machines 410 for processing subcluster data and content items of the subcluster 406.

Because the network traffic (and/or the data size) of the subcluster 406 is lower than that of the subcluster 404, the virtual machines 410 are smaller in number (and/or capacity) than the virtual machines 408. Indeed, the subcluster system 102 spins up fewer and/or smaller virtual machines for the subcluster 406 to prevent or avoid wasteful usage of computing resources storing and accessing data for rare, intermittent network traffic. The subcluster system 102 can thus adjust computational resource allocation on a per-subcluster basis, enabling more efficient storage and searching of content items. Further, by providing the increased number of virtual machines 408 for the subcluster 408 and content stored thereon, latency is reduced for those users searching for the content located on the subcluster 408.

In some cases, the subcluster system 102 detects an increase in network traffic for the subcluster 404. To elaborate, the subcluster system 102 detects an increased volume or frequency of search requests and/or other client device interactions from the client devices 412 for accessing content items within the subcluster 404. In response to detecting the increase in network traffic, the subcluster system 102 adjusts the virtual machines 408 accordingly. For example, the subcluster system 102 adds additional virtual machines (as indicated by the “+” in the figure) and/or increases the capacity of the virtual machines managing the subcluster 404 to accommodate the increased network traffic, thereby preventing slowdowns or crashes. By contrast, in some cases the subcluster system 102 detects a decrease in network traffic for the subcluster 404 due to a decreased volume or frequency of search requests or other client-device interactions for the content items within the subcluster 404, and in response the subcluster system 102 adjusts the virtual machines 408 downward, in number and/or capacity, as suitable.

In some embodiments, the subcluster system 102 adjusts the virtual machines 408 using a predictive model. For example, the subcluster system 102 analyzes historical network traffic data for the subcluster 404 to determine traffic levels at various times of day, week, and/or month. The subcluster system 102 can thus implement a heuristic model to preemptively modulate the virtual machines 408 based on predicted increases or decreases in network traffic. In some cases, the subcluster system 102 can train a neural network (or some other machine learning model architecture) to predict network traffic for the subcluster 404 based on historical network traffic statistics. In embodiments, the subcluster system 102 detects that traffic patterns change responsive to certain events, such as announcements by a genealogical research service regarding newly acquired content of a type corresponding to the subcluster 404, and can include such predictions as part of the heuristic model. Other patterns can be detected and are contemplated as part of the disclosed embodiments; for instance, it may be detected that content of particular types or categorizations on subcluster 404 is pertinent to particular categories of a genealogical research service who exhibit particular research patterns, such as researching at certain times of day or the week, and adjustments may be made based on cross-sections of users identified as being associated with particular subclusters.

For the subcluster 406, by contrast, the subcluster system 102 does not detect an increase in network traffic for the subcluster 406. More specifically, the subcluster system 102 determines consistent network traffic and therefore maintains the virtual machines 410 without adding more. In some cases, if the subcluster system 102 detects a decrease in network traffic, the subcluster system 102 can remove or reduce virtual machines for a subcluster as well. Accordingly, the subcluster system 102 can adapt computing resources on a per-subcluster basis rather than treating all content items in the genealogical content database 402 the same with a universal set of virtual machines, as is done in many prior systems.

As further illustrated in FIG. 4, the subcluster system 102 can spin up and maintain redundant virtual machines (or replications) for the subcluster 404 (as indicated by the “×2” in the figures). In particular, the subcluster system 102 can determine that the network traffic of the subcluster 404 satisfies a network traffic threshold to warrant a redundant set of virtual machines in case the virtual machines 408 fail, undergo hardware and/or software updates, or otherwise experience network delay or failure. In some cases, the subcluster system 102 provides redundant virtual machines for the subcluster 404 based on determining that the subcluster 404 includes content items of a certain content type (e.g., newspaper images). Indeed, the subcluster system 102 can determine to replicate or not replicate certain subclusters based on one or more factors, such as content type, network traffic, and/or an importance level designated by an administrator device.

In some embodiments, the subcluster system 102 determines not to provide redundant virtual machines for the subcluster 406 based on determining that the subcluster 406 does not satisfy a threshold level of network traffic and/or determining that the subcluster 406 includes content items of a certain content type (e.g., person-specific newspaper article content items). Redundancy may be established and maintained for particular subclusters on other bases as well, for example to account for a downtime associated with the process of instantiating new virtual machines. If, for example, a certain time period is required between instantiating the spin up of new virtual machines for a subcluster, redundancy may be provided to account for this down time in anticipation of impending search requests based on expected network traffic patterns.

While FIG. 4 illustrates a particular example of adjusting allocation of computational resources due to network traffic considerations, the subcluster system 102 can perform resource adjustments for other reasons as well. For example, the subcluster system 102 can perform resource adjustments for content updates and/or hot swaps.

To elaborate, the subcluster system 102 periodically updates one or more subclusters. Indeed, the subcluster system 102 receives uploads of new content items to the genealogical content database 402 and determines which subclusters to place the new content items in. The subcluster system 102 determines the subclusters as described above, by determining content types (and/or other features) associated with the content items. In some cases, the subcluster system 102 updates different subclusters with different cadences, updating subclusters with more network traffic (e.g., the subcluster 404) more frequently than subclusters with less network traffic (e.g., the subcluster 406). In response to detecting at least a threshold change in a subcluster (e.g., a threshold number or proportion of new content items) or a threshold change in network performance of virtual machines due to an update, the subcluster system 102 determines modifications to virtual machines for the subcluster. If a subcluster is not changed and/or less than a threshold amount of its data has been modified, the subcluster system 102 can determine not to update the subcluster, thereby saving additional computational resources.

Regarding hot swaps, the subcluster system 102 can replace or update indexes on a per-subcluster basis. For example, the subcluster system 102 can replace an index of content items within one subcluster without impacting indexes in other subclusters. In some cases, the subcluster system 102 performs a hot swap in response to detecting or receiving a content update for a subcluster. Indeed, the subcluster system 102 can receive or ingest new content items and can reindex the content items for the corresponding subcluster. In some embodiments, the subcluster system 102 performs hot swaps without experience interruptions and without making content items within subclusters unavailable for search or access. For instance, the subcluster system 102 spins up a redundant subcluster on alternative virtual machines while reindexing an identical subcluster on its virtual machines. The subcluster system 102 can further spin down the redundant subcluster once the hot swap is complete and the new index is finished.

In one or more embodiments, the subcluster system 102 performs blue deployment operations and/or green deployment operations. In particular, the subcluster system 102 updates or modifies various components without shutting down or interrupting network service for subclusters. To elaborate, the subcluster system 102 can increase (blue deployment) or decrease (green deployment) a number of virtual machines, can update hardware running the virtual machines, and/or can perform software updates for one or more virtual machines without interrupting network service and while facilitating continued search requests and corresponding content retrieval. The subcluster system 102 can detect or predict when to perform blue/green deployment for shards or virtual machines associated with subclusters and can accordingly adjust the virtual machines to compensate for downtime. For instance, the subcluster system 102 can spin up additional virtual machines for the subcluster 404 based on detecting a hot swap or predicting an impending hot swap, thus preventing network crashes or interruptions.

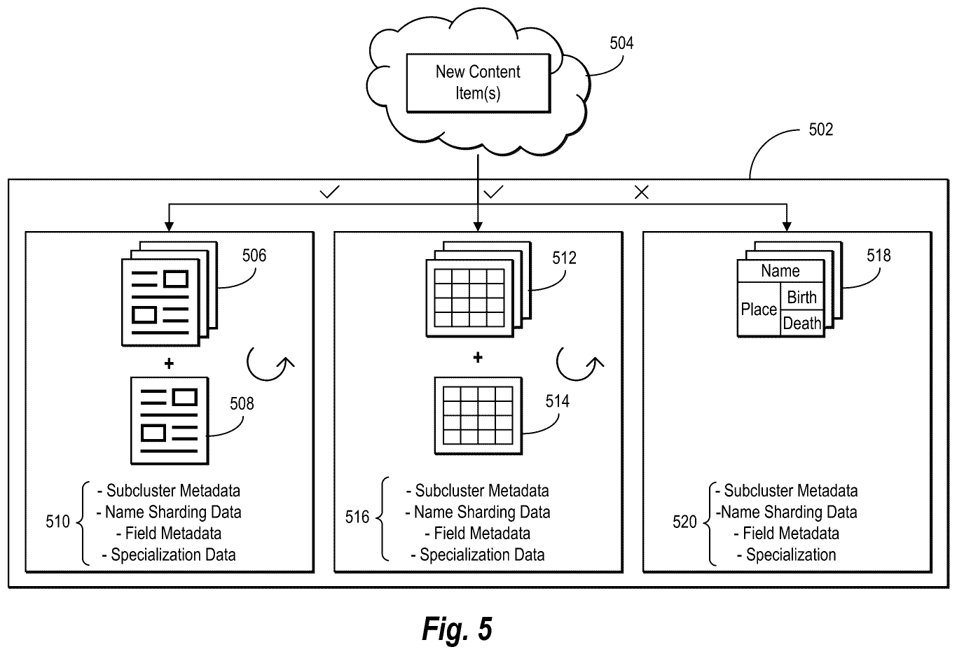

As just mentioned, the subcluster system 102 can perform resource adjustments to modify the allocation of virtual machines dedicated to subclusters based on a content update. For example, the subcluster system 102 can detect a content update that involves ingesting new content items into a genealogical content database and can update subclusters and virtual machines corresponding thereto accordingly. FIG. 5 illustrates an example diagram for updating subclusters based on receiving or ingesting new content items in accordance with one or more embodiments.

As illustrated in FIG. 5, the subcluster system 102 receives new content items 504. For example, the subcluster system 102 receives the new content items 504 in the form of a new upload for newly generated birth, marriage, and death record images, newly entered military records, newly discovered person-specific newspaper articles, recently generated DNA records, updated genealogy trees, and/or other modifications to content items stored in a genealogical content database 502. As shown, the subcluster system 102 receives or ingests the new content items 504 into the genealogical content database 502 and funnels the new content items 504 into their corresponding subclusters.

For instance, the subcluster system 102 identifies birth, marriage, and death record images to add to the corresponding subcluster 506 and further identifies military records to add to the corresponding subcluster 512. In response to adding new content items, the subcluster system 102 further scales the computational resources of the subcluster 506 and the subcluster 512 accordingly (e.g., by adding new virtual machines in proportion to, e.g., the volume of the newly acquired content and/or in response to a predicted number of search requests corresponding thereto). As shown, the subcluster system 102 does not identify new person-specific newspaper article records (as indicated by the “X”) and thus maintains the virtual machines for the corresponding subcluster 518. The subcluster system 102 thus preserves computational resources by, instead of updating all data across the entire genealogical content database 502, updating only those subclusters affected by the new content items 504, engaging only the virtual machines of the corresponding subclusters 506, 512. Thus, the subcluster system 102 does not update the subcluster data 520 for the subcluster 518. Accordingly, the subcluster system 102 can modify computational resources allocation on a per-subcluster basis based on content updates.

As illustrated in FIG. 5, the subcluster system 102 identifies a content item 508 to add to the subcluster 506. In response to adding the content item 508, the subcluster system 102 reindexes or updates the subcluster 506 which results in refreshing various subcluster data 510, such as: i) subcluster metadata indicating parameters of the subcluster 506 (e.g., subcluster data size, content type or other features of content items in the subcluster 506, a number of content items in the subcluster 506, and allocation data for virtual machines assigned to the subcluster 506); ii) name-sharding data indicating name-based separations or delineations between data partitions within the subcluster 506, where content items for different groups of names are hosted at different shards; iii) field metadata indicating parameters of data fields of content items within the subcluster 506 (e.g., creation times, data sizes, sources, data types, and other information for individual data fields); and/or iv) specialization data indicating relatedness between data fields of content items within the subcluster 506.

Regarding the name-sharding data, the subcluster system 102 can perform a name-sharding process to separate content items on a name-specific basis. To elaborate, the subcluster system 102 can group content items corresponding to one set of names (e.g., surnames beginning with the letters “a” through “g”) separately from content items corresponding to another set of names (e.g., surnames beginning with the letters “h” through “s”). The subcluster system 102 can further assign the different name-based groups to separate server shards for storing and performing searches. In some cases, the subcluster system 102 performs name sharding within a single subcluster and/or across multiple subclusters. The subcluster system 102 thus allocates computational resources more efficiently and with better performance through name sharding, especially for content item types with very large volume (large numbers of content items), such as person-specific newspaper articles, that would otherwise bog down a single shard. The name-sharding procedure(s) described above may include sharding according to one or more practices described in U.S. Patent Application Publication No. 2023/0021868, published Jan. 26, 2023. It will be appreciated that while name sharding is described, the disclosure is not limited thereto. Rather, sharding may be performed according to any suitable dimension, such as name, date, geographical location, etc., and combinations thereof.

Regarding the specialization data, the subcluster system 102 can generate and store specialization data that defines relatedness between fields of a single content items and/or across multiple content items. For instance, specialization data can define a relationship or commonality between the “mother” field and the “father” data field of a content item by generating a label of “parent” which can be used as an additional or alternative search term to identify content items that include the term “parent” but not “mother” or “father.” Indeed, the subcluster system 102 can generate a specialization data field that encompasses multiple metadata fields or that otherwise describes a content item. In some cases, the subcluster system 102 can generate subclusters based on specialization data and/or can perform searches using specialization data to compare with search queries.

The subcluster system 102 similarly updates subcluster data 516 for the subcluster 512 in response to detection the addition of the content item 514. In addition, the subcluster system 102 can update or scale virtual machines for subclusters based on changes to subcluster data, such as cluster metadata indicated increased data size, field metadata indicated complex or large data fields, specialization data indicating new relationships between data fields, and/or name-sharding data indicating new partitions between content items in the clusters.

The components of the subcluster system 102 can include software, hardware, or both. For example, the components of the subcluster system 102 can include one or more instructions stored on a computer-readable storage medium and executable by processors of one or more computing devices. When executed by one or more processors, the computer-executable instructions of the subcluster system 102 can cause a computing device to perform the methods described herein. Alternatively, the components of the subcluster system 102 can comprise hardware, such as a special purpose processing device to perform a certain function or group of functions. Additionally or alternatively, the components of the subcluster system 102 can include a combination of computer-executable instructions and hardware.

Furthermore, the components of the subcluster system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the subcluster system 102 may be implemented as part of a stand-alone application on a personal computing device or a mobile device.

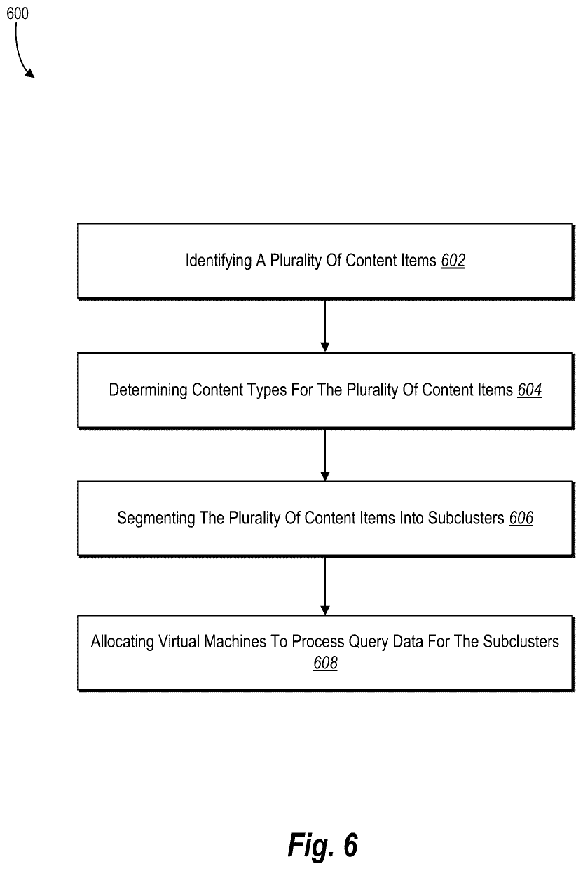

FIGS. 1-5, the corresponding text, and the examples provide a number of different systems and methods for generating and allocating resources for subclusters of content items. In addition to the foregoing, implementations can also be described in terms of flowcharts comprising acts steps in a method for accomplishing a particular result. For example, FIG. 6 illustrate example series of acts for allocating virtual machines based on segmenting clustered digital content into subclusters for search requests.

While FIG. 6 illustrates acts according to certain implementations, alternative implementations may omit, add to, reorder, and/or modify any of the acts shown in FIG. 6. The acts of FIG. 6 can be performed as part of a method. Alternatively, a non-transitory computer-readable medium can comprise instructions, that when executed by one or more processors, cause a computing device to perform the acts of FIG. 6. In still further implementations, a system can perform the acts of FIG. 6.

As illustrated in FIG. 6, the series of acts 600 includes an act 602 of identifying a plurality of content items. In particular, the act 602 involves identifying a plurality of content items stored within a genealogical content database of a genealogical data system. In some cases, the act 602 involves identifying a plurality of content items stored within a content database of a cloud data system. In addition, the series of acts 600 includes an act 604 of determining content types for the plurality of content items. In particular, the act 604 involves determining content types for respective content items within the plurality of content items stored in the genealogical content database. In some cases, the act 604 involves determining content types for respective content items within the plurality of content items stored in the content database. As shown, the series of acts 600 includes an act 606 of segmenting the plurality of content items into data subclusters. For example, the act 606 involves segmenting the plurality of content items into data subclusters separated according to the content types. Further, the series of acts 600 includes an act 608 of allocating virtual machines to process query data for the data subclusters. For example, the act 608 involves allocating a first number of virtual machines of a cloud computing system to a first data subcluster from among the data subclusters and a second number of virtual machines of the cloud computing system to a second data subcluster from among the data subclusters for processing data queries on a per-subcluster basis according to computational demands of the data subclusters.

In some embodiments, the series of acts 600 includes an act of determining the content types for the respective content items by: determining a first content type for a first content item from among the plurality of content items stored within the genealogical content database and determining a second content type for a second content item from among the plurality of content items stored within the genealogical content database. In these or other embodiments, the series of acts 600 includes an act of receiving, from a client device, a content-based search request defining a request to retrieve content items of an indicated content type and determining, via a cloud-computing orchestrator, a set of virtual machines to access for a data subcluster corresponding to the content-based search request.

The series of acts 600 can include an act of determining the set of virtual machines to access for the data subcluster corresponding to the content-based search request by: identifying, from among a set of aliases assigned to the data subclusters, an alias corresponding to the content-based search request, determining that the alias is associated with the data subcluster, and selecting the set of virtual machines allocated to the data subcluster associated with the alias to fulfill the content-based search request. In some embodiments, the series of acts 600 includes an act of determining the set of virtual machines to access for the data subcluster corresponding to the content-based search request by: determining one or more shards that host the data subcluster corresponding to the content-based search request and identifying the set of virtual machines from the one or more shards hosting the data subcluster.

In some embodiments, the series of acts 600 includes an act of utilizing a cloud-computing orchestrator to determine, in response to a search request, content items to access from the genealogical content database according to one or more of: cluster metadata defining parameters of the data subclusters separated according to the content types, name-sharding data defining name-based separations between data partitions within the data subclusters, field metadata defining parameters of data fields of content items from among the plurality of content items stored within the genealogical content database. The series of acts 600 can also include an act of maintaining a first set of specialization data for the first data subcluster at the first number of virtual machines a second set of specialization data for the second data subcluster at the second number of virtual machines, wherein specialization data defines relatedness between data fields of content items from among the plurality of content items.

In one or more embodiments, the series of acts 600 includes an act of allocating the first number of virtual machines to the first data subcluster comprises spinning up redundant virtual machines for a first content type of content items within the first data subcluster. In the same or other embodiments, the series of acts 600 includes an act of allocating the second number of virtual machines to the second data subcluster comprises spinning up a minimum number of virtual machines without redundancy for a second content type of content items within the second data subcluster.

Additionally, the series of acts 600 includes an act of detecting an increase in computational demand for the first data subcluster. The series of acts 600 can also include an act of, in response to detecting the increase in computational demand for the first data subcluster, automatically scaling the first data subcluster by increasing the first number of virtual machines and not scaling the second data subcluster by retaining the second number of virtual machines. In addition, the series of acts 600 can include an act of generating a façade pattern overlaying the data subclusters and mapping computer operations for a cloud-computing orchestrator to perform on content items within the data subclusters in response to data queries. The series of acts 600 can also include an act 600 of implementing the façade pattern by executing computer code to determine which shards to search in response to a search request.

In some embodiments, the series of acts 600 includes an act of determining which shards to search in response to the search request by determining a data-subcluster alias associated with a content type corresponding to the search request. Further, the series of acts 600 can include an act of allocating the first number of virtual machines and the second number of virtual machines based on historical computational requirements for the data subclusters.

In certain embodiments, the series of acts 600 includes an act of updating the first data subcluster and the second data subcluster independently of one another by: utilizing the first number of virtual machines to reindex content items at a first timing interval for the first data subcluster and utilizing the second number of virtual machines to reindex content items at a second timing interval for the second data subcluster, wherein the second timing interval is different from the first timing interval. In some embodiments, the series of acts 600 includes an act of receiving, from a client device, a global search request defining a request to retrieve content items from the content database. The series of acts 600 can also include an act of determining, via a cloud-computing orchestrator, a first set of virtual machines to access for a first data subcluster corresponding to the global search request and a second set of virtual machines to access for a second data subcluster corresponding to the global search request.

In one or more embodiments, the series of acts 600 can include an act of assigning data-subcluster aliases to the data subclusters separated from the plurality of content items according to the content types. The series of acts 600 can also include an act of receiving, from a client device, a search request to search the plurality of content items stored within the content database and an act of determining, from the data subclusters, a data subcluster corresponding to the search request by comparing aliases assigned to the data subclusters with the search request. Further, the series of acts 600 can include an act of generating search results for the search request by utilizing a façade pattern to determine one or more virtual machines allocated to the data subcluster according to an alias of the data subcluster.

By providing a system, method, and/or computer-program product for subclustering content items for allocating computational resources on a per-subcluster basis as described in the embodiments of the present disclosure, it has been found that the problem of existing content systems and search modalities therefor being rigid and computationally inefficient can be addressed. That is, the subcluster-generation, maintenance, and search functionalities of the disclosed embodiments advantageously reduce latency and computational-resource requirements by providing an improved subclustering approach that reduces a number of virtual machines—and the costs associated therewith—needed to receive user search requests, identify shards housing the relevant content, and then retrieve the relevant content for serving up to the user of, e.g., a genealogical research. It has been surprisingly found that a subclustering approach as described herein advantageously reduces costs of housing and serving up searched-for content by a shocking 94% compared to previous approaches. That is, an order-of-magnitude reduction in processing cost has been realized through the subclustering embodiments of the present disclosure.

It will be appreciated that while genealogical-record storage embodiments have been described, the disclosure is not limited thereto. Rather, the disclosure extends to any suitable application of the disclosed embodiments in any suitable context, such as with regards to financial records, medical records, legal records, or other data types.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates a block diagram of exemplary computing device 700 (e.g., the server(s) 104 and/or the client device 108) that may be configured to perform one or more of the processes described above. One will appreciate that server(s) 104 and/or the client device 108 may comprise one or more computing devices such as computing device 700. As shown by FIG. 7, computing device 700 can comprise processor 702, memory 704, storage device 706, I/O interface 708, and communication interface 710, which may be communicatively coupled by way of communication infrastructure 712. While an exemplary computing device 700 is shown in FIG. 7, the components illustrated in FIG. 7 are not intended to be limiting. Additional or alternative components may be used in other implementations. Furthermore, in certain implementations, computing device 700 can include fewer components than those shown in FIG. 7. Components of computing device 700 shown in FIG. 7 will now be described in additional detail.

In particular implementations, processor 702 includes hardware for executing instructions, such as those making up a computer program. As an example and not by way of limitation, to execute instructions, processor 702 may retrieve (or fetch) the instructions from an internal register, an internal cache, memory 704, or storage device 706 and decode and execute them. In particular implementations, processor 702 may include one or more internal caches for data, instructions, or addresses. As an example and not by way of limitation, processor 702 may include one or more instruction caches, one or more data caches, and one or more translation lookaside buffers (TLBs). Instructions in the instruction caches may be copies of instructions in memory 704 or storage device 706.

Memory 704 may be used for storing data, metadata, and programs for execution by the processor(s). Memory 704 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 704 may be internal or distributed memory.

Storage device 706 includes storage for storing data or instructions. As an example and not by way of limitation, storage device 706 can comprise a non-transitory storage medium described above. Storage device 706 may include a hard disk drive (HDD), a floppy disk drive, flash memory, an optical disc, a magneto-optical disc, magnetic tape, or a Universal Serial Bus (USB) drive or a combination of two or more of these. Storage device 706 may include removable or non-removable (or fixed) media, where appropriate. Storage device 706 may be internal or external to computing device 700. In particular implementations, storage device 706 is non-volatile, solid-state memory. In other implementations, Storage device 706 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 708 allows a user to provide input to, receive output from, and otherwise transfer data to and receive data from computing device 700. I/O interface 708 may include a mouse, a keypad or a keyboard, a touch screen, a camera, an optical scanner, network interface, modem, other known I/O devices or a combination of such I/O interfaces. I/O interface 708 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 708 is configured to provide graphical data to a display for presentation to a user. The graphical data may be representative of one or more graphical user interfaces and/or any other graphical content as may serve a particular implementation.

Communication interface 710 can include hardware, software, or both. In any event, communication interface 710 can provide one or more interfaces for communication (such as, for example, packet-based communication) between computing device 700 and one or more other computing devices or networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 710 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 710 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 710 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 712 may include hardware, software, or both that couples components of computing device 700 to each other. As an example and not by way of limitation, communication infrastructure 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 8 is a schematic diagram illustrating environment 800 within which one or more implementations of the subcluster system 102 can be implemented. For example, the subcluster system 102 may be part of a genealogical data system 802 (e.g., the genealogical data system 106). The genealogical data system 802 may generate, store, manage, receive, and send digital content (such as genealogical content items). For example, genealogical data system 802 may send and receive digital content to and from client devices 806 by way of network 804. In particular, genealogical data system 802 can store and manage genealogical databases for various user accounts, historical records, and genealogy trees. In some embodiments, the genealogical data system 802 can manage the distribution and sharing of digital content between computing devices associated with user accounts. For instance, the genealogical data system 802 can facilitate a user account sharing a genealogical content item with another user account of genealogical data system 802.

In particular, the genealogical data system 802 can manage synchronizing digital content across multiple client devices 806 associated with one or more user accounts. For example, a user may edit a digitized historical document or a node within a genealogy tree using client device 806. The genealogical data system 802 can cause client device 806 to send the edited genealogical content to the genealogical data system 802, whereupon the genealogical data system 802 synchronizes the genealogical content on one or more additional computing devices.

As shown, the client device 806 may be a desktop computer, a laptop computer, a tablet computer, an augmented reality device, a virtual reality device, a personal digital assistant (PDA), an in- or out-of-car navigation system, a handheld device, a smart phone or other cellular or mobile phone, or a mobile gaming device, other mobile device, or other suitable computing devices. The client device 806 may execute one or more client applications, such as a web browser (e.g., Microsoft Windows Internet Explorer, Mozilla Firefox, Apple Safari, Google Chrome, Opera, etc.) or a native or special-purpose client application (e.g., Ancestry: Family History & DNA for iPhone or iPad, Ancestry: Family History & DNA for Android, etc.), to access and view content over the network 804.

The network 804 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 806 may access genealogical data system 802.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
identifying a plurality of content items stored within a genealogical content database of a genealogical data system;
determining content types for respective content items within the plurality of content items stored in the genealogical content database;
segmenting the plurality of content items into data subclusters separated according to the content types; and
allocating a first number of virtual machines of a cloud computing system to a first data subcluster from among the data subclusters and a second number of virtual machines of the cloud computing system to a second data subcluster from among the data subclusters for processing data queries on a per-subcluster basis according to computational demands of the data subclusters.

2. The computer-implemented method of claim 1, wherein determining the content types for the respective content items comprises:
determining a first content type for a first content item from among the plurality of content items stored within the genealogical content database; and
determining a second content type for a second content item from among the plurality of content items stored within the genealogical content database.

3. The computer-implemented method of claim 1, further comprising:
receiving, from a client device, a content-based search request defining a request to retrieve content items of an indicated content type; and
determining, via a cloud-computing orchestrator, a set of virtual machines to access for a subcluster corresponding to the content-based search request.

4. The computer-implemented method of claim 3, wherein determining the set of virtual machines to access for the subcluster corresponding to the content-based search request comprises:
identifying, from among a set of aliases assigned to the data subclusters, an alias corresponding to the content-based search request;
determining that the alias is associated with the subcluster; and
selecting the set of virtual machines allocated to the subcluster associated with the alias to fulfill the content-based search request.

5. The computer-implemented method of claim 3, wherein determining the set of virtual machines to access for the subcluster corresponding to the content-based search request comprises:
determining one or more shards that host the subcluster corresponding to the content-based search request; and
identifying the set of virtual machines from the one or more shards hosting the subcluster.

6. The computer-implemented method of claim 1, further comprising utilizing a cloud-computing orchestrator to determine, in response to a search request, content items to access from the genealogical content database according to one or more of:
cluster metadata defining parameters of the data subclusters separated according to the content types;
name-sharding data defining name-based separations between data partitions within the data subclusters; or
field metadata defining parameters of data fields of content items from among the plurality of content items stored within the genealogical content database.

7. The computer-implemented method of claim 1, further comprising maintaining a first set of specialization data for the first data subcluster at the first number of virtual machines and a second set of specialization data for the second data subcluster at the second number of virtual machines, wherein specialization data defines relatedness between data fields of content items from among the plurality of content items.

8. A non-transitory computer readable medium storing instructions which, when executed by at least one processor, cause the at least one processor to:
identify a plurality of content items stored within a content database of a cloud data system;
determine content types for respective content items within the plurality of content items stored in the content database;
segment the plurality of content items into data subclusters separated according to the content types; and
allocate a first number of virtual machines of a cloud computing system to a first data subcluster from among the data subclusters and a second number of virtual machines of the cloud computing system to a second data subcluster from among the data subclusters for processing data queries on a per-subcluster basis according to computational demands of the data subclusters.

9. The non-transitory computer readable medium of claim 8, further storing instructions which, when executed by the at least one processor, cause the at least one processor to:
allocate the first number of virtual machines to the first data subcluster comprises spinning up redundant virtual machines for a first content type of content items within the first data subcluster; and
allocate the second number of virtual machines to the second data subcluster comprises spinning up a minimum number of virtual machines without redundancy for a second content type of content items within the second data subcluster.

10. The non-transitory computer readable medium of claim 8, further storing instructions which, when executed by the at least one processor, cause the at least one processor to:
detect an increase in computational demand for the first data subcluster; and
in response to detecting the increase in computational demand for the first data subcluster:
automatically scale the first data subcluster by increasing the first number of virtual machines; and
not scale the second data subcluster by retaining the second number of virtual machines.

11. The non-transitory computer readable medium of claim 8, further storing instructions which, when executed by the at least one processor, cause the at least one processor to generate a façade pattern overlaying the data subclusters and mapping computer operations for a cloud-computing orchestrator to perform on content items within the data subclusters in response to data queries.

12. The non-transitory computer readable medium of claim 11, further storing instructions which, when executed by the at least one processor, cause the at least one processor to implement the façade pattern by executing computer code to determine which shards to search in response to a search request.

13. The non-transitory computer readable medium of claim 12, further storing instructions which, when executed by the at least one processor, cause the at least one processor to determine which shards to search in response to the search request by determining a subcluster alias associated with a content type corresponding to the search request.

14. The non-transitory computer readable medium of claim 8, further storing instructions which, when executed by the at least one processor, cause the at least one processor to allocate the first number of virtual machines and the second number of virtual machines based on historical computational requirements for the data subclusters.

15. A system comprising:
one or more memory devices; and
one or more processors coupled to the one or more memory devices, wherein the one or more processors are configured to cause the system to:
identify a plurality of content items stored within a content database of a data system;
determine content types for respective content items within the plurality of content items stored in the content database;
segment the plurality of content items into data subclusters separated according to the content types; and
allocate a first number of virtual machines of a cloud computing system to a first data subcluster from among the data subclusters and a second number of virtual machines of the cloud computing system to a second data subcluster from among the data subclusters for processing data queries on a per-subcluster basis according to computational demands of the data subclusters.

16. The system of claim 15, wherein the one or more processors are further configured to cause the system to update the first data subcluster and the second data subcluster independently of one another by:
utilizing the first number of virtual machines to reindex content items at a first timing interval for the first data subcluster; and
utilizing the second number of virtual machines to reindex content items at a second timing interval for the second data subcluster, wherein the second timing interval is different from the first timing interval.

17. The system of claim 15, wherein the one or more processors are further configured to cause the system to:
receive, from a client device, a global search request defining a request to retrieve content items from the content database; and
determine, via a cloud-computing orchestrator, a first set of virtual machines to access for a first subcluster corresponding to the global search request and a second set of virtual machines to access for a second subcluster corresponding to the global search request.

18. The system of claim 15, wherein the one or more processors are further configured to cause the system to assign subcluster aliases to the data subclusters separated from the plurality of content items according to the content types.

19. The system of claim 18, wherein the one or more processors are further configured to cause the system to:
receive, from a client device, a search request to search the plurality of content items stored within the content database; and
determine, from the data subclusters, a data subcluster corresponding to the search request by comparing aliases assigned to the data subclusters with the search request.

20. The system of claim 19, wherein the one or more processors are further configured to cause the system to generate search results for the search request by utilizing a façade pattern to determine one or more virtual machines allocated to the data subcluster according to an alias of the data subcluster.
